(19) United States
(12) Patent Application Publication
(10) Pub. No.: US 2024/0243692 A1
(43) Pub. Date: Jul. 18, 2024

(54) SUPPORT STRUCTURE FOR PV MODULES

(71) Applicant: sbp sonne gmbh, Stuttgart (DE)

(72) Inventors: Markus Balz, Wolfschlugen (DE); Matthis Bohn, Stuttgart (DE); Martin Frank, Stuttgart (DE); Uli Dillmann, Stuttgart (DE)

(21) Appl. No.: 18/556,759

(22) PCT Filed: Apr. 29, 2022
(86) PCT No.: PCT/EP2022/061581

§ 371 Date: Jan. 9, 2024

(30) Foreign Application Priority Data
Apr. 29, 2021 (DE) 10 2021 111 106.4

(51) Int. Cl. H02S 20/24

(52) U.S. Cl. CPC H02S 20/24

(57) ABSTRACT

The invention relates to a support structure for PV modules, which allows the erection of large-area PV plants above parking lots or surfaces for agricultural use.

The invention relates to a system for generating electrical energy by means of photovoltaics (PV) on a surface that is also used for other purposes. For example, the PV system is to be installed on a parking lot for motor vehicles or on a surface used for agriculture, such that motor vehicles are parked or agriculture is carried out under the PV modules.

Photovoltaic systems that are to be installed and operated on a parking lot for motor vehicles or on a surface used for agriculture must fulfill various technical and economic framework conditions. In particular, they must be cost effective, relatively easy to erect, and require as little construction material as possible. Of course, they must also have sufficient rigidity to withstand high wind loads, such as storm gusts.

All structures, the main dimensions of which (length, width) are very large in relation to the thickness of their support structure, are prone to vibrations that are excited, for example, by gusts of wind. It must therefore be ensured that vibrations of the support structure or the PV system do not occur or that the amplitudes of these vibrations remain small enough that no damage occurs to the support structure and the PV modules. It must be taken into account that the PV modules are predominantly made of brittle “glass” material.

These tasks are solved according to the invention by a support structure for photovoltaic modules, comprising a plurality of rows of supports extending side by side and a plurality of tensioning straps running side by side, wherein the supports of a row are respectively connected to each other by a cross-member, wherein the tensioning straps run transversely to the cross-members and wherein photovoltaic modules are arranged on the tensioning straps and wherein the tensioning straps are fastened to the cross-member at the crossing points of a cross-member and a tensioning strap by means of a screw connection or a clamp connection.

The support structure according to the invention thus comprises a plurality of partially very long rows of cross-members. Tensioning straps are arranged between these cross-members, which straps are in themselves and inherently flexible. The tensioning straps achieve sufficient rigidity through adequate pretensioning. The pretensioning force in the tensioning straps is determined by aeroelastic wind tunnel tests as well as computer-aided simulations in such a way that an economic optimum is achieved while at the same time reducing the aerodynamic effects—vibrations. The pretensioning thus also depends on the location of the PV system. In a location with high wind speeds, a greater pretension is required than in a location with low maximum wind speeds.

The elongation of the tensioning straps caused by the pretensioning is so great that at any point in time, but also in the case of a wind-induced vibration, the pretensioning is greater than zero. This also applies for the very brief moment when a vibrating tensioning strap is perfectly horizontal and not sagging. At said point in time, which can also be called the “zero crossing” of the vibrational amplitude, the (stretched) length of the tensioning strap is minimal because it “occupies” the shortest connection between two adjacent seating points. Even then, a certain amount of pretensioning is still present.

The PV modules are attached to these tensioning straps. The construction according to the invention is extremely lightweight, cost effective and yet very resilient.

The supports of the support structure according to the invention are so long that the cross-members and the tensioning straps together with the PV modules attached to them have a height above the ground of, for example, 5 or 6 meters. Therefore, they cannot be touched and damaged, for example, by a vehicle parked in a parking lot created under the PV modules. The same applies if the support structure according to the invention is erected in connection with surfaces used for agriculture. In this case, the clear height of the cross-members, as well as also of the tensioning straps, must be dimensioned in such a way that the machines and vehicles required for cultivating the agricultural surface can at least pass under the tensioning straps. This is usually sufficient. In some cases, it is also desirable to be able to drive under the cross-members.

The main dimensions of such a support structure, namely the length and width of the base area spanned by the support structure, can be well over 100 m, so that a peak power of well over several megawatts [MWₚₑₐₖ] can be installed. Such a long and wide/large area structure is, however, also sensitive to aeroelastic vibrations excited by wind loads. The amplitudes of these vibrations, which are dangerous for the PV modules, can be reduced to a harmless level by sufficient pretensioning of the tensioning straps.

In a particularly advantageous, economical and efficient configuration, it is provided that the tensioning straps are made of corrosion-protected steel sheet and that there are punch-throughs in the tensioning straps for attaching PV modules to the tensioning strap and/or attaching the tensioning straps to the cross-member at the crossing points between a cross-member and a tensioning strap.

The tensioning strap can, for example, be made of a high-strength steel sheet with a thickness of 2 to 4 mm, preferably 3 mm, and a width of 50 mm to 150 mm. This gives a sufficiently high tensile strength to apply the required pretension. Inasmuch as the tensioning strap is relatively thin, it can nevertheless be easily wound onto a spool/reel and transported in this way to the installation site. To install the tensioning strap, such a spool or reel is passed over the cross-members and unwound. The tensioning strap then lies over the cross-members (still without pretension). In a subsequent step, the required pretension is applied.

If the tensioning straps are made from an “endless” strip of high-strength steel sheet, then punch-throughs (circular holes, oblong holes or otherwise shaped punch-throughs) can be made in the tensioning strap at suitable points by punching, laser cutting or other means. With the aid of these punch-throughs, it is then very easy to attach several PV modules to the tensioning straps, for example, with the aid of clamping pieces. The same applies to the connection between the tensioning strap and the cross-members at the crossing points between the tensioning strap and the cross-member.

In this way, the prefabrication of the individual components (and cross-members) can be carried out to a very large extent in the workshop and the components prepared in this way can then be easily assembled on site.

Of course, alternative forms of tensioning straps are also possible, namely steel ropes, fiber ropes made of non-metallic fibers such as glass fibers, carbon fibers or aramid fibers or mixtures of these fiber materials.

The tensioning straps are usually attached at the crossing points of a cross-member on the top of a cross-member, preferably by means of a clamp or alternatively a frictional or force fit. This means that there is no stress concentration and the tensioning strap is effectively prevented from lifting off the cross-member, for example, as a result of a gust of wind.

Alternatively, the tensioning straps can also be passed along the underside of the cross-members and be fastened. This can simplify the erection of the support structure. In this case, the tensioning straps are unrolled under the cross-members and then pulled up.

In addition, the clamping of the tensioning straps at the crossing point causes stiffening between the adjacent cross-members so that the support structure as a whole is stabilized and stiffened.

To prevent a buckling or an increased bending stress in the tensioning strap, the upper side of the cross-member is curved in a convex manner at least at the crossing points of a cross-member and a tensioning strap and the tensioning strap rests on the curved upper side of the cross-member. It is possible to configure this curvature as an integral part of the cross-member by manufacturing a tube or a welded hollow section from steel sheets, the upper side of which has the desired curvature. It is, however, also possible to configure the cross-members, for example, as a square tube, and to place a saddle wherever the tensioning straps run over the cross-member, and to screw or connect it to the cross-member, wherein the saddle has the desired curvature.

The cross-members can also be made from a renewable raw material, in particular wood (for example, structural solid wood). In this case, too, it is advantageous to produce the curvature on the upper sides of the cross-members, for example, by means of a profile cutter directly in the cross-members.

In some cases, the embodiment with mounted saddle components is particularly economical to manufacture inasmuch as the cross-members are then made from commercially available steel tubes or squared timber available on the market, this whether they are configured with a round, square or rectangular cross-section. The saddle components are then mounted on these cross-members and, for example, clamped to the cross-members with tensioning screws. Among other things, this facilitates transport of the individual parts to the construction site. The saddle components are then assembled on site.

Alternatively, it is also possible for the tensioning straps to be composed of individual sections, with one section extending between each of two adjacent cross-members. One end of the tensioning strap section is then attached to one cross-member and the opposite end of the tensioning strap section is then attached to the adjacent cross-member. In this construction, attachment tabs can, for example, be welded to the cross-members at the appropriate points or clamped to the cross-members in the form of half-shells. The sections are then cut to size and installed pretensioned between the cross-members.

It is also possible for a section of tensioning strap to extend over two or more cross-members. In this case, even very large support structures can be produced economically.

A plurality of tensioning strap sections arranged one after another form a continuous tensioning strap extending from a first cross-member to a last cross-member. For the rigidity of the support structure according to the invention, it is irrelevant whether the tensioning strap is configured in one piece or consists of several tensioning strap sections that are arranged one after another and have the same effect as a continuous tensioning strap.

At least two footings are provided to divert the tensioning forces to be applied to the tensioning straps from the first cross-member and the last cross-member. A first footing runs essentially parallel to the first cross-member and a second footing runs parallel to the last cross-member. As a rule, these footings are arranged outside the area covered by the support structure according to the invention. In this case, suitable traction means can be used to easily divert the pretensioning forces from the first cross-member to the first footing, and the pretensioning forces of the tensioning straps can be diverted from the last cross-member to the second footing.

The footings must absorb the pretensioning forces of the tensioning straps and transfer them into the soil. They can be configured as strip or pad footings. They can also be formed from micropiles and/or ground anchors. The pad footings, micropiles and/or ground anchors are arranged in rows parallel to the first or last cross-member in the soil. A connection between the first cross-member and the first footing can then, for example, be established by means of suitable traction means (for example, a steel cable). It is of course necessary to provide a plurality of traction means along the entire length of the cross-member, which, as already mentioned, can be 100 m or more, in order to transfer the pretensioning forces occurring along the entire length of the cross-member to the first footing. The same applies, of course, to the second footing and the last cross-member.

The surface covered by the tensioning straps is usually not completely occupied by PV modules. A partial occupancy can have the following advantages:

The dynamic pressures and aerodynamic superelevations resulting from wind loads can be reduced by only partial occupancy. At times, irregular occupancy of the tensioning straps with PV modules is also beneficial to reduce the amplitudes of wind-induced vibrational excitations of the support structure. These issues will be addressed through wind tunnel testing and/or simulation calculations.

In an application over agricultural land, the arrangement of the PV modules and the degree of coverage are defined by the plants growing on the agricultural land and their characteristics. From this point of view, it may be advantageous to arrange the PV modules in a plurality of self-contained sub-areas, wherein a certain spacing is provided between the sub-areas such that sufficient sunlight falls on the plants and the shadow cast, or alternatively duration of the shading sustained by one of the sub-areas, is distributed as evenly as possible. For this purpose, the sub-areas can be distributed in the manner of a checkerboard pattern.

According to the invention, it may be provided that the tensioning straps can be spaced apart by a distance that corresponds approximately to the length of the PV modules to be mounted. In this case, the PV modules can rest with their short sides on two adjacent tensioning straps and be fastened there with the tensioning strap, for example using clamping elements or a screw connection. It is thereby possible that either the PV modules are arranged butt to butt or, in a manner similar to a shingle roof, are arranged partially overlapping.

Alternatively, it may be provided that the tensioning straps can be spaced apart at a distance that corresponds approximately to the width of the PV modules to be mounted. In this case, the PV modules can rest with their long sides on two adjacent tensioning straps and be fastened there with the tensioning strap, for example, using clamping elements or a screw connection. A short tensioning width can be particularly advantageous for so-called glass-glass PV modules. In this case, it is possible that either the PV modules are arranged butt to butt or, in a manner similar to a shingle roof, are arranged partially overlapping.

It is alternatively possible with the support structure according to the invention to arrange the PV modules directly on the tensioning straps, without a frame, using suitable clamping elements and sealing strips. This embodiment is particularly lightweight and cost effective and offers the wind less of an attack surface because the PV modules are even lower than PV modules surrounded by an (aluminum) frame. It is however also possible to use PV modules with a frame on the support structure according to the invention. Then the PV module is connected to the tensioning straps via the frame. This embodiment is somewhat more robust, but the construction costs are higher and the attack surface for the wind is larger.

Of course, it is also possible to use a combination of PV modules with and without frames. In this way, the advantages of both embodiments can be combined.

In order to ensure that any rain that may occur does not reach the vehicles or the agricultural surface below in an uncontrolled manner, seals are provided between adjacent PV modules. As a result, the impinging rainwater is collected, for example, with the aid of a rain gutter, and fed for a further use in a controlled manner. By way of example, the rainwater can be collected in a storage tank and later used to water the plants growing there.

In a further advantageous configuration of the invention, the cross-members are constructed of a wide flange beam, of a hollow section, in particular a steel tube, or of wood, in particular solid structural wood. Both the hollow sections and the wooden cross-members can hereby have a round or polygonal cross-section.

In a further advantageous configuration, at least the upper sides of the cross-members are curved and form a seating for the tensioning straps.

In a preferred configuration of the invention, a saddle component for a tensioning strap is provided at each crossing point, wherein the saddle components are connected to the cross-members. The saddle components can be screwed to the cross-members or welded to the cross-members. The second alternative is of course only possible if the cross-members are made of a weldable metal, in particular steel.

It is moreover advantageous if each saddle component comprises a curved seating and a counterpiece, wherein the tensioning strap is passed between the seating and the counterpiece and the counterpiece is pressed against the seating by means of clamping screws. It is thereby possible to frictionally connect the tensioning strap in the area of the saddle component to the saddle component and thus also to the cross-member by means of a clamping connection. The curved seating ensures that the tensioning strap is never kinked, even when subjected to vibrations during operation, so that a stress concentration in the seating area is reliably avoided.

If the clamping piece and the associated clamping screws are sufficiently dimensioned, it is then possible to connect the tensioning strap at the crossing points exclusively by friction through the clamping pieces to the saddle component and the cross-member. Punch-throughs in the tensioning straps are then not required, which has advantages in material utilization and reduces the risk of concentrations of stress in the area of the punch-throughs, which can be a potential source of failure.

It is provided in an advantageous configuration that the saddle components comprise one or two ribs, that the seating is attached to the rib or ribs, preferably by welding, that a base plate is arranged below the seating on the rib or ribs, and that the base plate has punch-throughs or threaded holes that work together with the clamping screws and the clamping pieces.

This embodiment of the saddle components is preferably configured as a welded construction. It allows the saddle components to be placed on conventional hollow sections and welded in place. The base plate extends transversely under the seating surface through the saddle component and projects beyond the seating on both sides, such that with an appropriately dimensioned clamping piece it is possible to pass the tensioning strap between the clamping piece and the seating and to press the clamping piece against the base plate using the clamping screws. In this way, the frictional connection between the tensioning strap and the saddle component is created.

Inasmuch as this embodiment is a welded construction, all components can be optimally configured in terms of material thickness and their dimensions, so that a very lightweight, cost effective, and nevertheless reliable and safe fastening of the tensioning straps at the crossing points can be realized.

In the support structure according to the invention, each PV module may be arranged directly or indirectly on two tensioning straps located next to each other. If the PV modules comprise a frame, then the PV modules are preferably attached via the frame to two tensioning straps running side by side. It is then also possible to attach the PV modules to the tensioning straps in an elevated position. In the context of the invention, elevated means that a normal vector of the PV modules and a tangent to the tensioning strap, where the PV module is arranged on the tensioning strap, do not enclose an angle of 90°, but rather, for example, enclose an angle of only 60°. This makes it possible to optimally orient the PV modules such that they capture as much solar radiation as possible and their performance and efficiency are improved.

In the case of the elevated design, it is preferred if at one end of the PV module, the frame or alternatively the PV module is attached directly to the tensioning strap and the desired distance between the frame of the PV module and the tensioning strap is produced at the other end by means of a strut, in order to, in this way, bring about the optimum orientation of the PV module.

Further advantages and advantageous configurations of the invention can be seen in the following drawings, their description and the patent claims. All features disclosed in the drawings, their descriptions and the patent claims can be essential to the invention both individually and in any combination with each other.

### DRAWINGS

Wherein:

FIG. 1 to FIG. 33 show various views and embodiments of the support structure according to the invention; FIG. 34 shows the erection of a support structure according to the invention;

FIG. 35 and FIG. 36 show traction means with disk spring assemblies; and FIG. 37 and FIG. 38 show details of an embodiment with multiple tensioning straps arranged one after another.

### DESCRIPTION OF THE EMBODIMENT EXAMPLES

In the figures, the same reference signs are used for the same components. Not all components are given reference signs in all figures in order to maintain clarity.

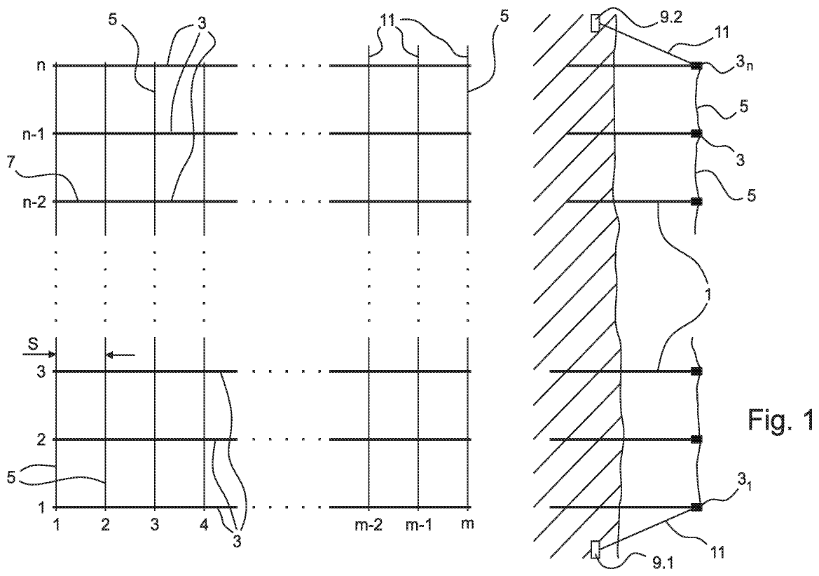

FIG. 1 shows a top view and a side view of a support structure according to the invention in a highly simplified form to illustrate the basic construction.

In the left part of FIG. 1, a top view of the support structure according to the invention (without PV module) is represented. The right part of FIG. 1 shows a side view of the support structure according to the invention, here too without PV modules.

The support structure according to the invention consists of a plurality of supports 1 arranged below the cross-members 3. As can be seen from the top view of FIG. 1, a plurality of cross-members 3 are arranged parallel to each other. In the embodiment example shown, there are a total of “n” cross-members 3. The numbering of the cross-members 3 from “1” to “n” is indicated on the left side of FIG. 1.

“m” tensioning straps 5 are arranged and fastened on or alternatively to the cross-members 3. They run parallel to each other and, in this embodiment example, at right angles to the cross-members 3. A distance s between two adjacent tensioning straps 5 often corresponds to the length of one PV module. This means that a PV module (not shown) with a rectangular footprint rests with its end faces on two adjacent tensioning straps 5 and can there be firmly connected to them.

As a rule, it is advantageous if the PV modules are arranged in such a way that the long sides of the PV modules rest on the tensioning straps 5 and are fastened there, inasmuch as this reduces the mechanical load on the PV modules. The tensioning straps are curved in the shape of an arc, or in the shape of a catenary. The radius of curvature of the catenary is, however, extremely large due to the pretensioning. Only a negligible deflection of the PV modules results from the attachment of the PV modules to the long sides. In the side view of FIG. 1, the curvature of the tensioning straps 5 is indicated graphically. It is, however, not to scale.

Wherever a tensioning strap 5 crosses a cross-member 3, a crossing point 7 is created, of which only one is marked with a reference sign in FIG. 1. In total, there are therefore “n” times “m” crossing points 7.

In the side view of FIG. 1, it can also be seen that the supports 1 can project into the ground so that they are firmly planted in the ground. The ground is indicated by hatching in the side view.

In a preferred embodiment, driven piles are rammed into the ground, the upper end of which then terminates at the level of the parking lot/agricultural surface. The supports are then placed on the upper ends of the driven piles and connected to them.

In the side view of FIG. 1, the first cross-member 31 and the last cross-member 3, can be seen. Outside the area spanned by the support structure, a first footing 9.1 is located in the ground. This first footing 9.1 runs parallel to the first cross-member 3.1. A second footing 9.2 is arranged symmetrically with respect to the last cross-member 3n.

Traction means 11 are provided in this embodiment example in order to be able to divert the pretension of the “m” tensioning straps 5, which pretension must respectively be applied by the first cross-member 3.1 and the last cross-member 3n, into the footings 9.1 and 9.2, which traction means divert the pretensioning forces running substantially in the horizontal direction and introduce them into the footings 9. The traction means 11 can, for example, consist of steel cables, threaded rods or a very thick steel wire with a diameter of, for example, 30 to 60 mm.

In the top view of FIG. 1, the footings 9 and the traction means 11 are not visible, or are only partially shown. The traction means 11 can, for example, always be arranged on the first cross-member 3.1 or alternatively on the last cross-member 3ₙ where a tensioning strap 5 is respectively attached to the cross-member 3.1 or alternatively 3ₙ. The pretensioning force is then introduced directly from the tensioning straps 5 to the traction means 11 without any significant bending moments being exerted on the cross-member 3. This arrangement is illustrated in the upper right of the top view of FIG. 1.

A very advantageous and economical variant provides that traction means 11 are only provided in the extensions of the axes formed by the supports.

As already mentioned, the dimensions of the support structure according to the invention are quite considerable. A length of the cross-members 3 can be more than 100 m. In a corresponding manner, the length of the tensioning straps 5 may also be more than 100 m, so that the surface covered by the support structure is greater than 1 hectare. Accordingly, the height of the supports 1 is also selected in such a way that there is a clearance of at least 4 m, but often also 5 m or more, between the ground and the tensioning straps 5 or the cross-members 3.

In this way, vehicles, in particular large tractors and trailers, can drive under the tensioning straps 5 or the PV modules located thereon without coming into contact.

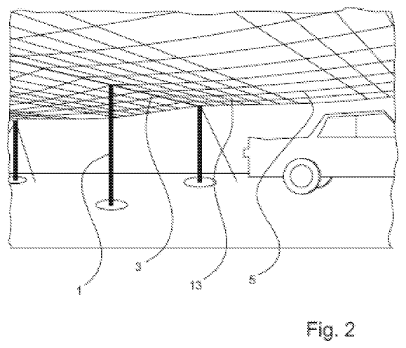

FIG. 2 shows an isometric view of an embodiment example. It results from this isometry that the entire surface covered by the support structure does not need to be covered with PV modules 13, but rather that an area can be left free in the lanes between parking spaces. This is to say that the PV modules 13 are only arranged where the vehicles park. In the locations where the vehicles drive, which is to say, in the lanes between the rows of parking spaces, no PV modules are placed.

Inasmuch as the entire surface covered by the cross-members and tensioning straps is not fully covered by PV modules but rather has repeated interruptions, the risk of wind-induced vibrations with large amplitudes is reduced. This also reduces the load on the tensioning straps and at the same time leads to a higher rigidity of the support structure according to the invention.

Moreover, sunlight shines through to the surface below the PV modules through those areas not occupied by PV modules. In many cases, this sunlight is sufficient to allow an agricultural surface or alternatively the plants located there to grow and flourish. Inasmuch as the plants are only exposed to direct sunlight for a relatively short period of the day, there is less risk of them drying out or “burning.” This means that even in hot, dry summers, vegetables or other crop plants can be grown that cannot withstand the heat without shade. The occupancy of the support structure, or the ratio of module area to base area of the support structure, can be adjusted to the local climate and crop plants. By way of example, the support structure would be more densely covered with PV modules if it were installed in Saudi Arabia than if it were installed in northern Germany.

The electricity yield of the PV modules can be increased by using bi-facial PV modules because part of the sunlight reflected from the ground then reaches the underside of the PV modules, where it is converted into electrical energy.

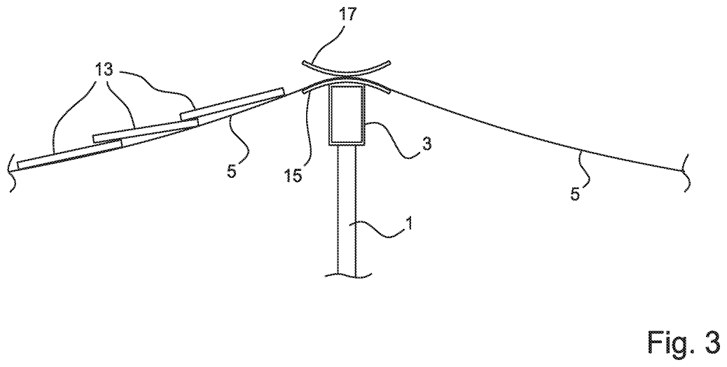

FIG. 3 shows a highly simplified detail of an embodiment example of a support structure according to the invention. This is a crossing point 7 between a cross-member 3 and a tensioning strap 5.

FIG. 3 shows the support 1, a cross-member 3 (in cross-section) and a tensioning strap 5. A plurality of PV modules 13 are shown on the tensioning strap 5 to the left of the cross-member 3. These PV modules 13 are laid on or alternatively attached to the tensioning strap 5 in the style of shingles or roof tiles. In FIG. 3, this means that the left end of one PV module 13 rests on the right end of the adjacent PV module 13 in such a way that the PV modules 13 overlap in a narrow area. This avoids the formation of a gap between the PV modules 13; the surface formed by the PV modules 13 is therefore “watertight.” Another advantage of this shingled arrangement is that two PV modules 13 can be attached to the tensioning strap 5 with only one clamping or fastening element (not shown in FIG. 3).

The PV modules 13 are configured as frameless modules in FIG. 3. This means that they are not surrounded by an aluminum frame or any other frame. This reduces the dead weight, the overall height and the costs. It is, however, of course also possible to mount PV modules 13, with frames, on the support structure according to the invention.

No PV modules are shown on the tensioning strap 5, which is located to the right of the cross-member 3. It goes without saying that PV modules can also be mounted there in a completed system.

A saddle component 15 is visible on the cross-member 3. The saddle component 15 is curved. The saddle component 15 bears the tensioning strap 5 and thereby also the weight forces of the PV modules 13, which must be introduced into the cross-member 3 and the supports 1 by means of the tensioning straps 5.

The saddle component 15 is curved on its upper side so that the tensioning strap 5 is guided over the cross-member 3 without kinking and without permanent deformation. The tensioning strap 5 can consist of a metal sheet strip made of high-strength steel and be, for example, 3 mm thick and 100 mm wide.

A counterpiece 17 is arranged above the saddle component 15. The tensioning strap 5 is guided between the saddle component 15 and the counterpiece 17. The counterpiece 17 can be screwed to the saddle component 15 or the cross-member 3 with screws which are not shown. This creates a clamp connection between the saddle component 15 and the counterpiece 17, which frictionally connects the tensioning strap 5 to the saddle component 15 or the cross-member 3. This clamping connection ensures that the tensioning strap 5 cannot move relative to the cross-member 3. This fixes and stabilizes the supports 1 in their vertical orientation. The clamping connection moreover secures the tensioning strap 5 against lifting off the saddle component 15 if a gust of wind impinges on the PV module 13 from below.

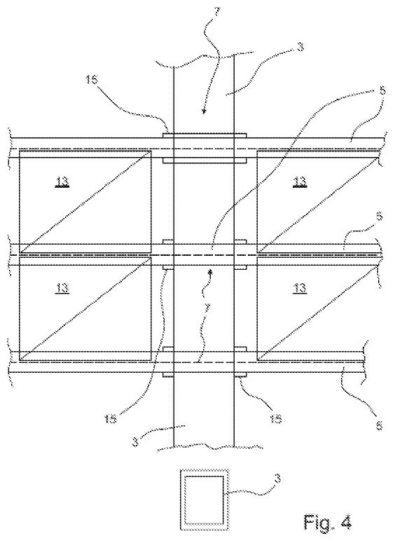

The arrangement according to FIG. 3 is shown from above in FIG. 4. This makes the constructional configuration of the crossing point 7 even clearer. In FIG. 4, by way of example, two PV modules 13 are arranged on the right and left of the cross-member 3. In this top view, it can be clearly seen that two PV modules respectively rest on a tensioning strap 5. With, for example, a width of the tensioning strap 5 of 100 mm, the seating surface of each PV module 13 on the tensioning strap 5 is about fifty millimeters wide. This is sufficient to securely fasten the PV modules 13 to the tensioning strap 5.

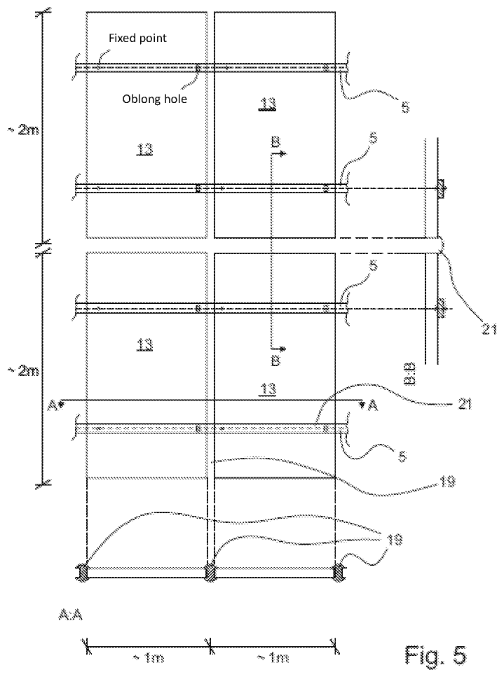

FIG. 5 shows a top view of a further embodiment example of a PV system according to the invention. This is only a section of a surface spanned by PV modules 13. There are no cross-members 3 or supports 1 present in this section. In truth, the section shows that seals or sealing profiles 19 are arranged between adjacent PV modules 13. This prevents direct contact between the PV modules 13, and protects them from damaging each other. The joint between the PV modules 13 is moreover sealed.

The sealing strip 19 or alternatively the sealing profile 19 is arranged in the joints between PV modules 13 that run parallel to the cross-member 3. A (sealing) profile that has the function of a rain gutter is arranged in the joints that run parallel to the tensioning strap 5. It is therefore also referred to as rain gutter 21. The sealing profile 19 and the rain gutter 21 can be made of a flexible and UV-resistant material, such as, for example, EPDM. Rainwater that hits the PV modules collects in the rain gutters 21 and is diverted downwards. At the lower edge of a surface covered by PV modules 13, the water draining off through the rain gutters 21 can be collected and fed, for example, to a rainwater storage tank or directly to the agricultural surface below the PV modules 13.

The PV modules 13 are arranged next to each other in the embodiment shown in FIG. 5. The width of the joints in which a sealing profile 19 is provided can, for example, be 5 mm. In the location where a flexible rain gutter 21 is to be arranged, the width of the joint can be 30 mm or 50 mm.

The edges of the PV modules 13 do not rest on the tensioning straps 5 in the embodiment example shown in FIG. 5. Rather, the PV modules rest on two tensioning straps 5. One tensioning strap 5 runs approximately one quarter (¼) of the length of the PV module 13, the other tensioning strap 5 runs approximately three quarters (¾) of the length of the PV module 13; this is the so-called mounting at quarter points. This reduces the bending stress on the PV module 13 and the (aluminum) frames of the PV module 13 can turn out to be smaller and more lightweight. The PV module 13 is fastened to the tensioning straps 5 by screwing the (aluminum) frames to the tensioning straps 5 in the positions recommended by the PV module manufacturer.

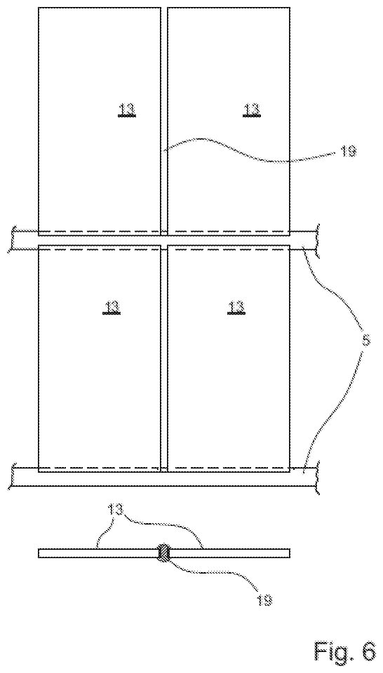

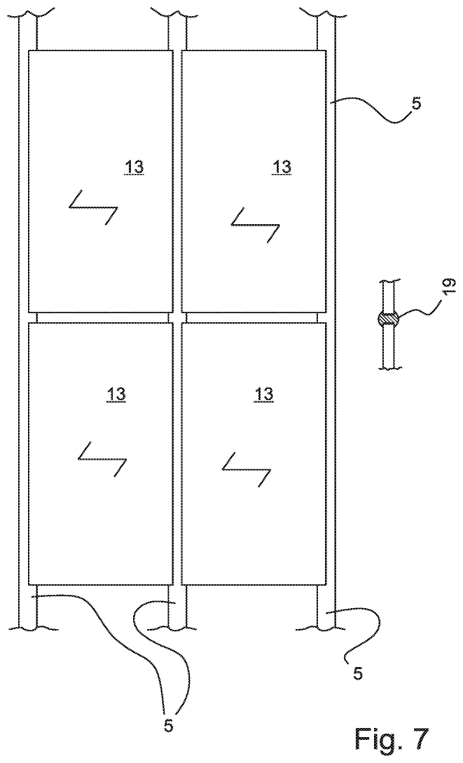

FIG. 6 and FIG. 7 show two further variants of the arrangement of PV modules 13 on tensioning straps 5. In FIG. 6, the short sides of the rectangular PV modules 13 rest on a tensioning strap 5. Two adjacent PV modules “share” the width of a tensioning strap. A sealing strip 19 is arranged in the joints that run perpendicular to the tensioning straps 5, between the PV modules 13. In the embodiment example shown in FIG. 7, the spacing of the tensioning straps 5 is selected such that the PV modules 13 rest with their long sides on two adjacent tensioning straps. Here, too, the seal 19 is provided in the joints which run perpendicular to the longitudinal axis of the tensioning straps 5. The rain gutter 21 (not shown) runs parallel to the tensioning straps.

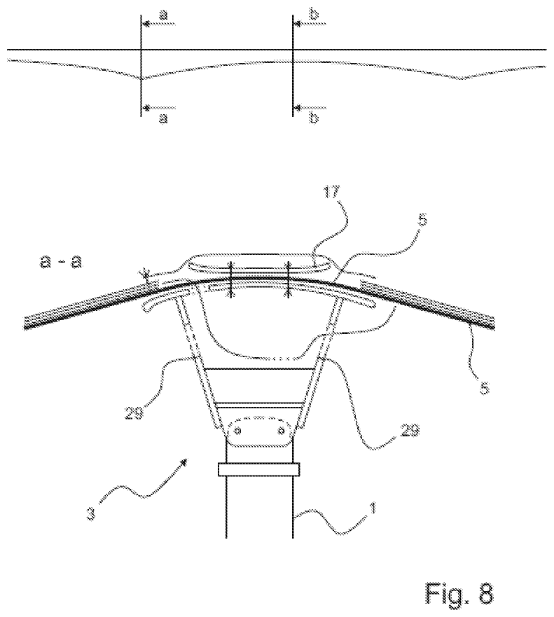

FIG. 8 shows details of a further embodiment in which the top of the cross-members 3 are curved. In this embodiment example, the top of the cross-member 3 acts as a saddle component. The cross-members 3 are made of steel and have a welded construction. This has the advantage that the main dimensions and the cross-section of the cross-member 3, as well as its material can be freely selected within wide limits.

An optional hand hole 29 is configured on both sides in the cross-member 3 shown in cross-section in FIG. 8. The hand holes 29 are large enough for the hand of an installer to reach into.

Screws or nuts can be inserted into the cross-member 3 through the hand holes 29. The screws or nuts are needed to fasten the counterpiece 17 to the top of the cross-member 3.

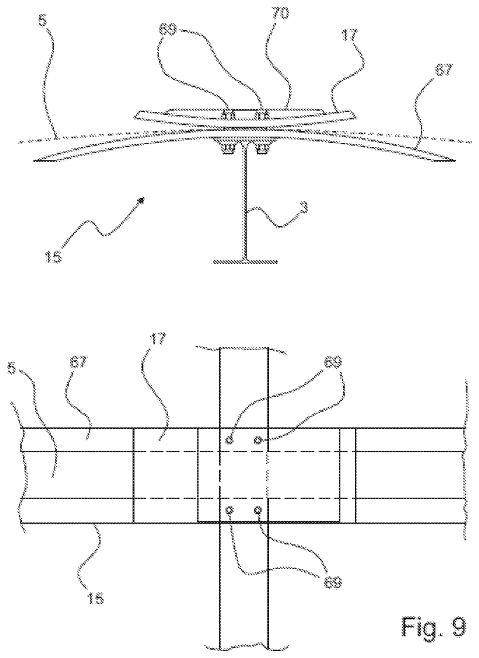

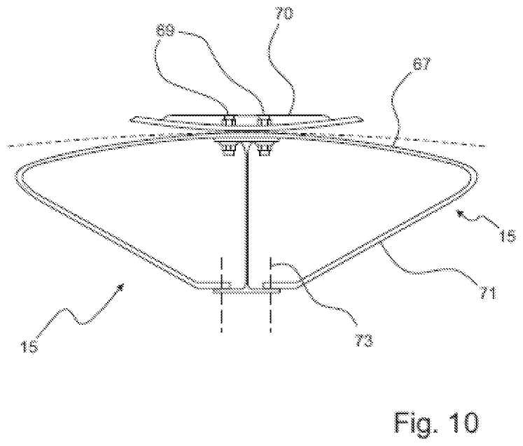

Various embodiment examples of saddle components 15 according to the invention are shown in FIG. 9 and FIG. 10. The cross-member 13 is configured as a wide flange profile in the embodiment example shown in FIG. 9. These profiles were previously also referred to as “double T-beams.” The supports which bear the cross-member 3 are not shown.

The saddle component 15 includes a curved seating 67. This curved seating can be manufactured from a metal sheet blank, for example by roll bending. The radius of curvature of the bent seating is significantly smaller than the curvature of the tensioning strap 5. The radius of curvature can, for example, be 1.5 m.

As a result, direct contact between the tensioning strap 5 and the seating 67 only occurs where the tensioning strap 5 passes between the seating 67 and the clamping piece 17. If, now, the tensioning strap 5 is caused to vibrate, for example, due to wind loads, the curvature of the seating 67 ensures that the tensioning strap 5 is not kinked. In truth the tensioning strap always rests tangentially on the seating 67.

In this embodiment example, the clamping screws 69 protrude through the clamping piece 17 and the seating 67 as well as the upper beam of the cross-member 3, which is executed as a wide flange profile. By tightening the clamping screws 69, the tensioning strap 5 is clamped between the seating 67 and the counterpiece 17, and is thus frictionally fixed.

It is not necessary to make any punch-throughs or holes in the tensioning strap 5 inasmuch as the saddle component 15 and the counterpiece 17 are wider than the tensioning strap 5. This is clearly shown in the top view in the lower part of FIG. 9.

At the construction site, the tensioning strap 5 is placed on the seating 67. As soon as the tensioning strap 5 is in the correct position and sufficient pretension has been applied, the clamping screws 69 are tightened. The counterpiece 17 is hereby drawn against the seating 67. In this way, the tensioning strap 5 is frictionally connected to the seating 67 and thus also to the cross-member 5.

FIG. 10 shows a variation of this saddle component 15. In the case of this saddle component 15, the seating 67 is configured as a bent metal sheet strip, the ends of which are supported on the lower flange of the cross-member 3. This connection between the ends of the bending part 71 and the lower flange of the cross-member 3 is indicated by dash-dotted line 73. Fastening screws can, for example, be inserted through the bending part 71 and the lower flange of the cross-member 3.

It is, however, also possible for the ends of the bending part to be frictionally connected to the lower flange of the cross-member 3 by means of clamping pieces (not shown). This has the advantage that the lower web of the cross-member 3 does not need to be provided with holes or punch-throughs. These holes or punch-throughs would reduce the flexural rigidity of the cross-member 3 and cause additional manufacturing expense. In many cases it can be more economical to use clamping pieces instead of holes/punch-throughs in the lower flange of the cross-member, which can be produced very cost effectively in large-scale industrial production.

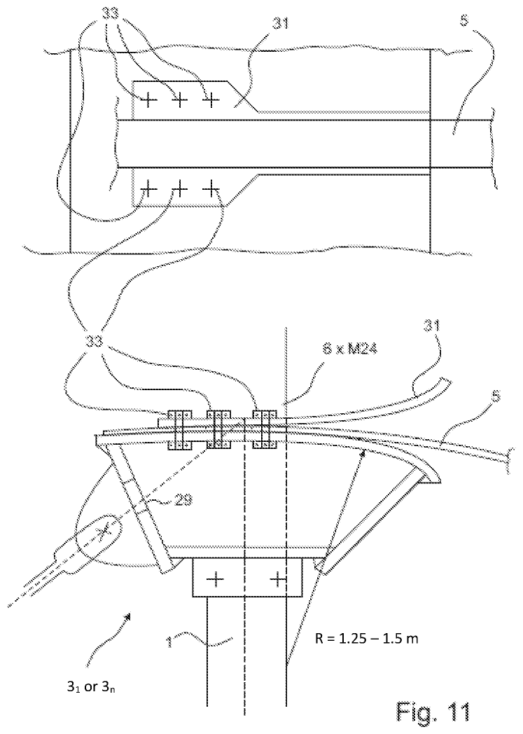

Details of a further embodiment are shown in FIG. 11. A first cross-member 3, or alternatively a last cross-member 3, are shown in this figure. These cross-members differ from the other cross-members 3 in that the tensioning straps 5 end there. The tensioning members 11 are moreover hooked there. The traction means 11 transfers the pretensioning force of the tensioning straps 5 into the footings 9 (see FIG. 1).

The counterpiece 31 is shaped in a similar manner to one of the counterpieces 17. The end of the tensioning strap 5 is inserted between the curved upper side of the cross-member 31 and the counterpiece 31. The counterpiece 31 is drawn against the cross-member 31 or 3, with the aid of several screws 33 and in this way a frictional connection is made between the end of the tensioning strap 5 and the cross-member 3.1 or alternatively 3ₙ. The pretensioning forces are transferred from the cross-member 3.1 or alternatively 3, to the tensioning strap 5 or introduced by it by means of this friction-locked connection.

On the left in FIG. 11, a tab is arranged on the cross-member 3.1 or alternatively 3ₙ. The traction means 11 (for example, a steel cable) is hooked there. The footing 9 at the other end of the traction means 11 is not shown in FIG. 11.

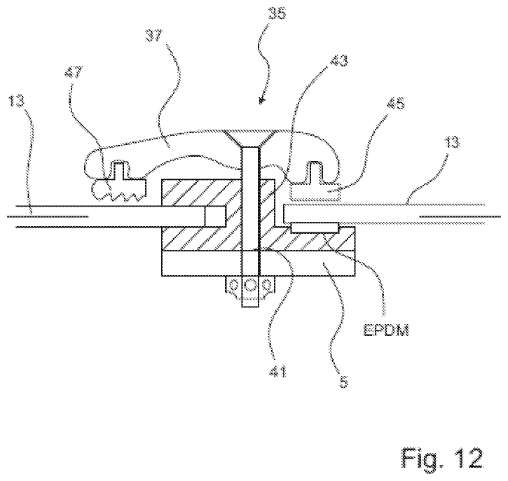

A first embodiment example of a clamping element 35 is shown in FIG. 12. It comprises a clamping piece 37, a tensioning screw 41, a sealing strip 43, a foot 45 as well as a pressure piece 47. The sealing strip 43 can have a constant cross-section or a cross-section that varies in height along its length, which enables an inclined, shingled mounting. The clamping piece 37 is arranged above the PV module 13. The tensioning screw 41 protrudes through the clamping piece 37 and the tensioning strap 5. When the tensioning screw 41 is tightened, the clamping piece 37 with the foot 45 and the pressure piece 47 is pressed against the PV module 13 from above. The foot 45 is made of a comparatively hard plastic. The foot presses on the PV module to the right of the tensioning screw 41. This PV module is only mounted on one side of the sealing strip 43. Therefore, the foot 45 presses directly on the PV module 13.

The PV module 13 found to the left of the tensioning screw 41 is accommodated in a groove of the sealing strip 43. The pressure piece 47 clamps the PV module 13 in the groove of the sealing strip 43. The pressure piece 47 can have ribs or bristles on its underside and/or be manufactured of a comparatively soft material.

As can be seen from FIG. 12, the clamping piece 37 is not symmetrical with respect to the tensioning screw 41. Rather, the lever arm between the tensioning screw 41 and the foot 45 is shorter than the lever arm between the tensioning screw 41 and the pressure piece 47. This means that the foot 45 exerts a higher contact force on the PV module 13 than the pressure piece 47. Therefore, the foot 45 forms a fixed support, so to speak. The location where the pressure piece 47 clamps the PV module 13 with less force is a “movable support.” Thermal stresses or other stresses are relieved by allowing the PV module 13 (in FIG. 11 the tensioning screw 41 on the left) to move slightly relative to the clamping element 35.

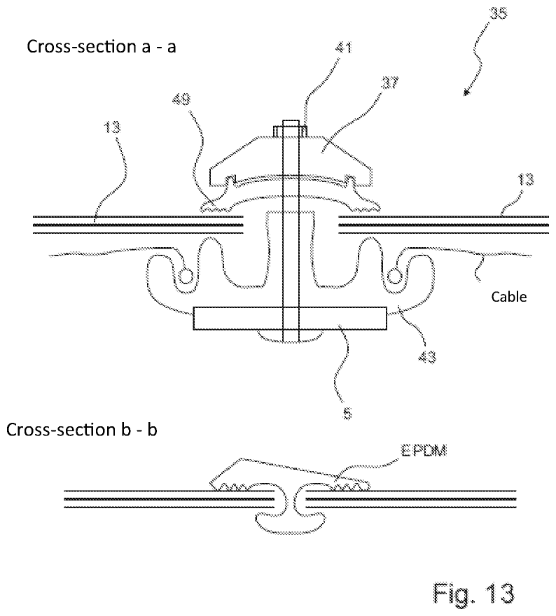

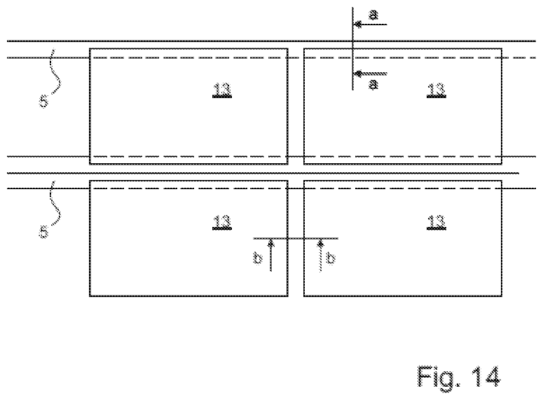

FIG. 13 shows a cross-section along the line a-a of FIG. 14. FIG. 13 shows another embodiment example of a clamping element 35 with a symmetrical arrangement. The sealing strip 43 is shaped differently. It comprises two lips of different heights.

A rubber element 49 is arranged below the clamping piece 37, which element distributes the clamping forces exerted by the clamping piece 37 and the tensioning screw 41 on the PV module 13 and protects the PV module 13 from damage.

FIG. 14 shows the arrangement of several PV modules without a frame and without shingling.

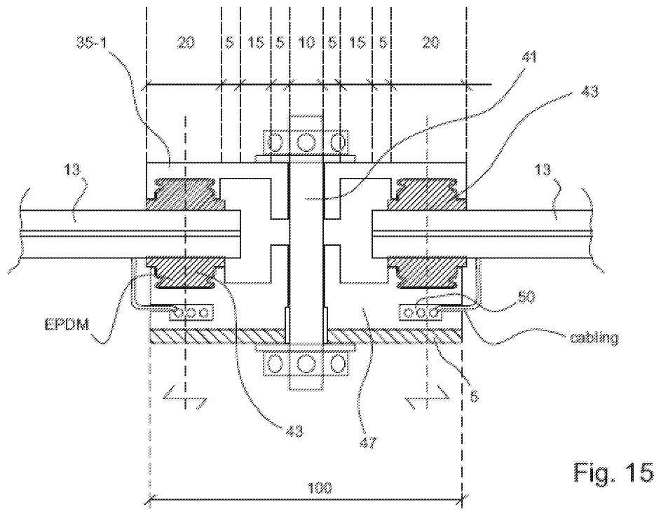

FIG. 15 shows a further embodiment example of a clamping element 35. As in FIG. 13, a symmetrical arrangement with respect to the tensioning screw 41 is, here too, provided. A channel 50 is formed for the electrical lines of the PV module 13 in the lower part 35-2 of the clamping element 35-2.

Both the upper and lower parts of the clamping element 35 in this embodiment are an extruded aluminum profile that runs parallel to the tensioning strap 5.

Sealing strips 43 are provided between the two parts 35-1 and 35-2 of the clamping element 35 and the PV modules 13.

The PV module 13 is clamped between the sealing strips 43 by tightening the tensioning screw 41.

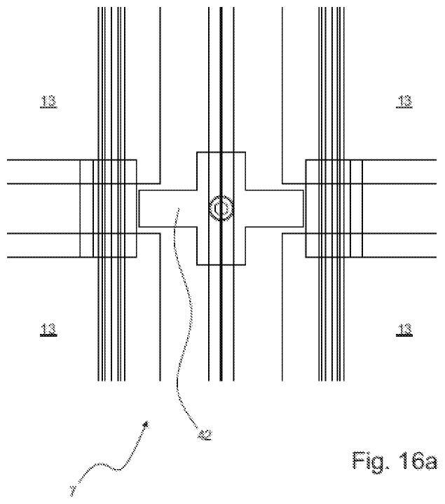

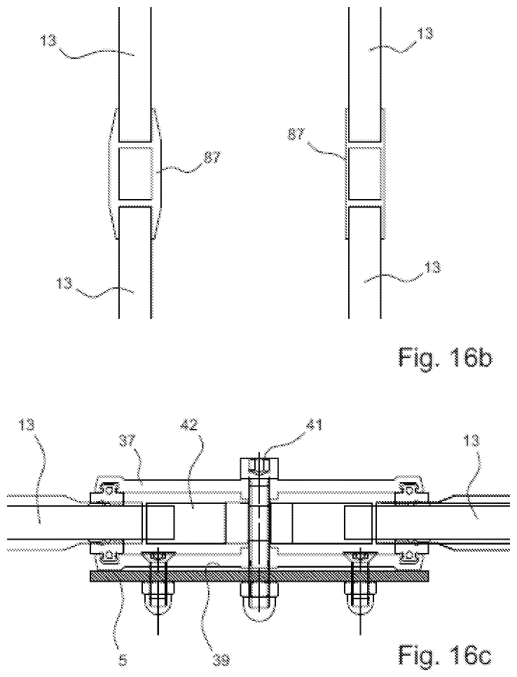

Details of the sealing in the area of a crossing point 7 are shown in FIG. 16. Four PV modules 13 “butt up” against each other at the crossing point, however, without touching. To prevent direct contact of the fragile PV modules 13, a spacer 42 is arranged with clearance between the corners of the PV modules 13. The spacer 42 may, for example, be made of a resilient plastic, such as EPDM.

The PV modules 13 and the spacer 42 are arranged on one plane, as can be seen, for example, from FIG. 16c.

FIG. 16c further shows that the PV modules 13 and the spacer 42 rest, at least in the area of the crossing point 7, on a lower clamping piece 37. The lower clamping piece 37 is connected to the tensioning strap 5 by one or a plurality of (countersunk) screws (no reference sign).

The PV modules 13 do not rest directly on the lower clamping piece 39, but rather on sealing strips 43, which in turn are accommodated in corresponding grooves of the clamping piece 39.

An upper clamping piece 39 with sealing strips 43 is arranged above the PV modules 13 and the spacer 42, at least in the area of the crossing point 7, which upper clamping piece can be executed with an identical construction to the lower clamping piece 37.

The PV modules 13 are fastened indirectly to the tensioning strap 5 via a tensioning screw 41 which passes through the clamping pieces 37, 39 and through the spacer 42.

A further sealing strip 87, which is shown in FIG. 16b and is executed as a hollow or box profile is provided outside the crossing point 7.

The sealing strip 87 is flattened in the area of the crossing point 7, to prevent material buildup where sealing strips 43 and sealing strips 87 cross. A flattened area is labeled “84” in FIG. 16b.

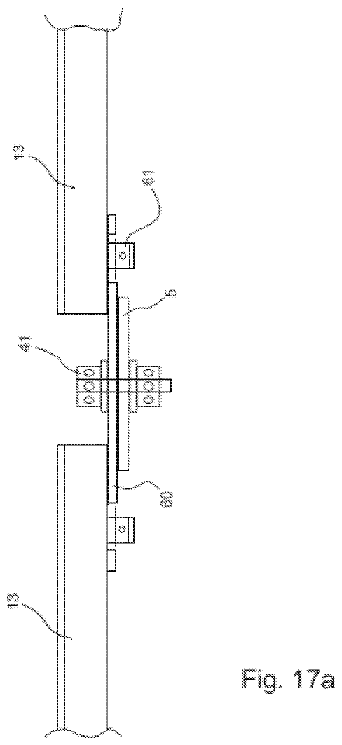

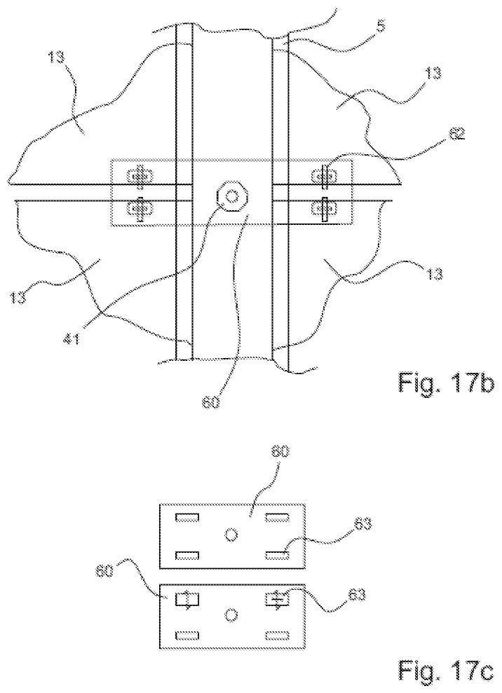

FIG. 17a, FIG. 17b and FIG. 17c show a connection between four PV modules 13 and a tensioning strap 5. A connecting piece 60 lies on the tensioning strap 5. It preferably consists of a metal sheet with four oblong holes 63 and a (central) mounting hole 64 or alternatively a punch-through.

Metal sheet tabs 61 with a hole (with no reference sign) protrude from the undersides of the PV modules 13. One metal sheet tab 61 is respectively inserted through one oblong hole 63. To prevent the PV module 13 from lifting off the tensioning strap 5 when caught by a squall, a split pin, pin or screw is inserted through the hole in the tab 61.

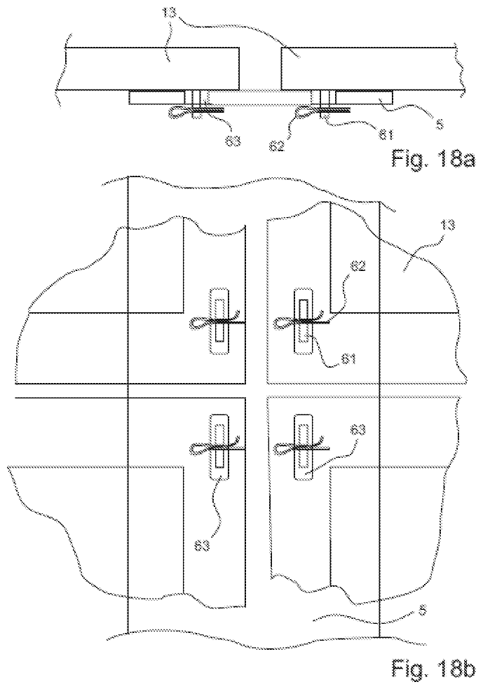

FIG. 18 shows an alternative to the embodiment shown in FIG. 17. Here, the oblong holes 63 are configured in the tensioning strap 5 such that no connecting piece 60 is required.

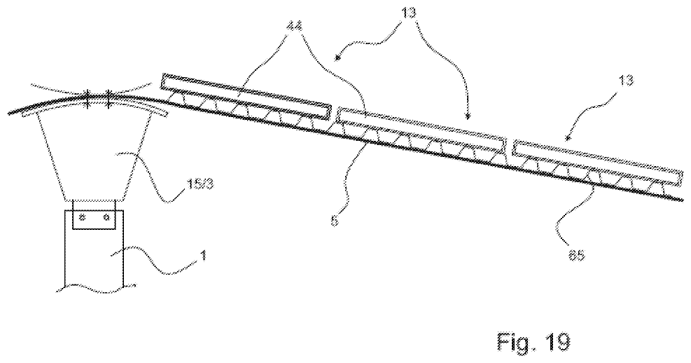

Another embodiment example of a support structure according to the invention is shown in FIG. 19. A trapezoidal metal sheet 65 is arranged between the tensioning straps 5 and the PV modules 13 in this embodiment example. This variant is very cost effective and “watertight” inasmuch as the trapezoidal metal sheet 65 reliably prevents rainwater from reaching the surface below the support structure. The water is drained off via the trapezoidal metal sheet, which is slightly inclined, and collected if necessary. Sealing strips (see reference signs 19 and 43 in the other figures) are not required for this purpose.

Trapezoidal metal sheets have a considerable load-bearing capacity at low dead weight and low cost, so that cost effective “standard” PV modules 13 with frame 44 can be mounted on the trapezoidal metal sheet. The frame 44 of these PV modules 13 can be very lightweight due to the small span widths. The trapezoidal metal sheet is riveted or screwed to the tensioning straps (which “sag” slightly despite the pretensioning).

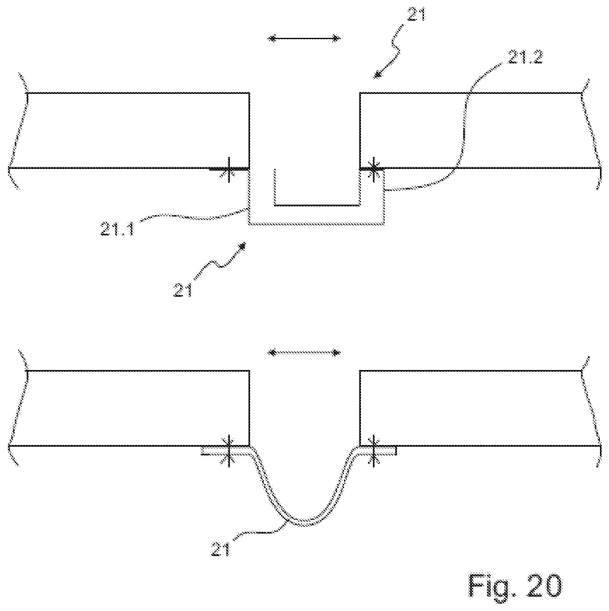

FIG. 20 shows two embodiment examples of rain gutters 21. The upper part of FIG. 20 shows a two-part rain gutter 21, which may consist of two plastic profiles or folded metal sheets. The two parts 21.2 and 21.2 are arranged in such a way to divert rainwater. The two parts of the rain gutter 21.1 and 21.2 are not fixed to each other, so that they can compensate for wind-induced deformations and/or thermal expansion. In the lower part of FIG. 20, a rain gutter 21 is indicated, which rain gutter consists of a strip of an elastic plastic material, such as EPDM.

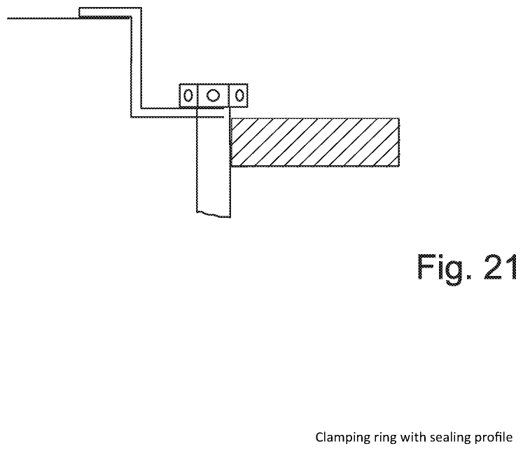

Further embodiments of the connection between PV modules 13 and tensioning straps 5, with the associated structural elements, are shown in FIG. 21 through FIG. 32.

In the embodiment example 1 shown in FIG. 21, the upper clamping element 37 is configured as an upside down “hat-shaped” rail with a central part and two lateral strips. A PV module with frame 44 is clamped between a lateral strip and the tensioning strap 5 when the tensioning screw 41 penetrating the central part and the tensioning strap 5 is tightened.

In the embodiment example 1 shown in FIG. 22, the PV module 13 (with or without frame) is clamped by means of a sealing strip 19, 43 when the tensioning screw 41 is tightened, which tensioning screw penetrates the sealing strip 19, 43 and the tensioning strap 5.

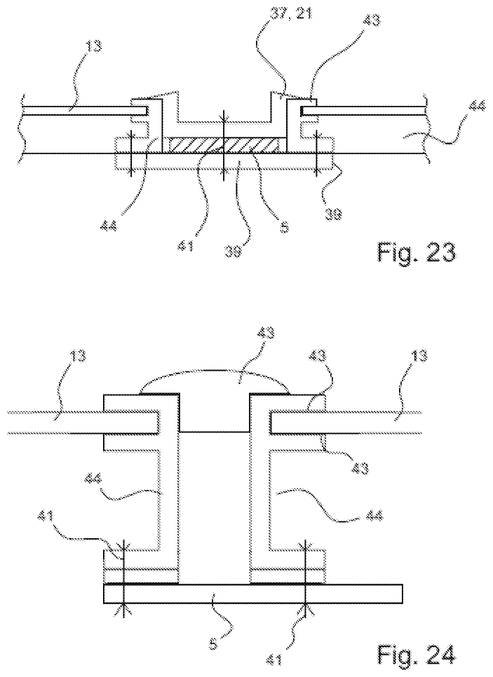

In the embodiment example 1 shown in FIG. 23, the PV module 13 is clamped by means of its frame 44. The upper clamping piece 37 is configured as a rain gutter. A sealing strip 43 is provided between the upper clamping piece 37 and the frame 44. The tensioning screw 41 penetrates the rain gutter 21, the tensioning strap 5, and the lower clamping piece 39.

In the embodiment example 1 shown in FIG. 24, the connection between a PV module 13 is made by the means of the frame 44. In the “lower” part, the frame 44 has a leg. The tensioning screw 41 penetrates this leg, an optional sealing strip, and the tensioning strap 5.

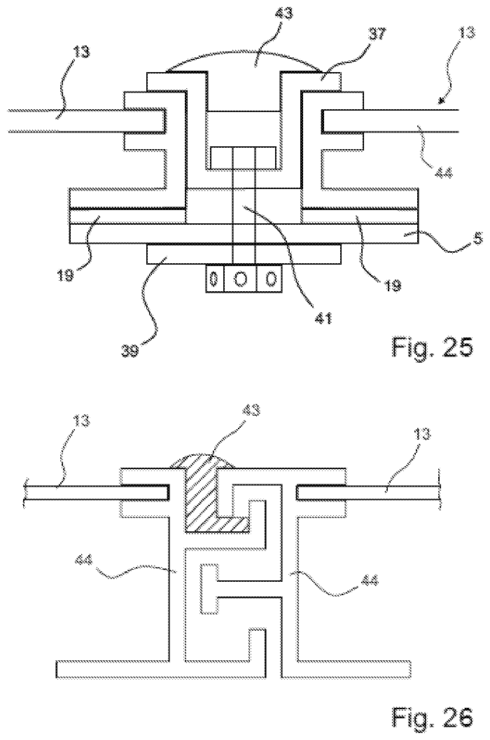

The embodiment example 1 shown in FIG. 25 illustrates a variant of the embodiment example shown in FIG. 21.

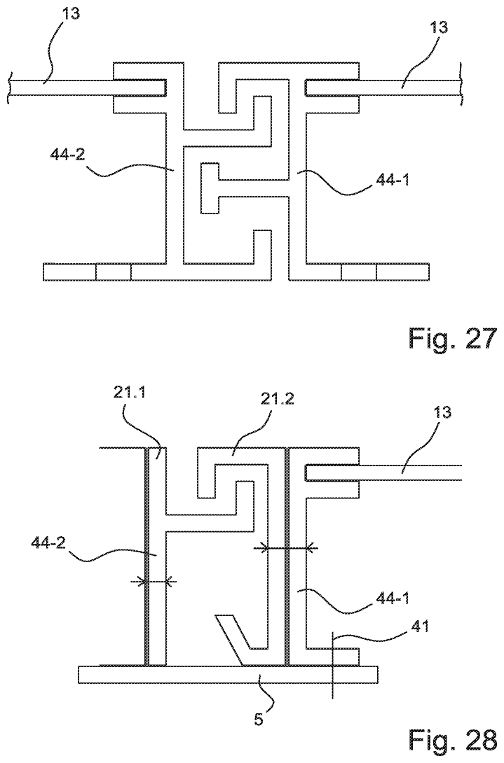

FIG. 26 and FIG. 27 show further variants of the embodiment example shown in FIG. 24. The adjacent frames 44 comprise “T”- and “L”-shaped ribs on the sides facing each other. The two frames 44 are thereby interlocked with each other and (rain) gutters are formed which can drain off rainwater. A sealing strip 43 is provided in FIG. 26, which sealing strip prevents the ingress of rainwater.

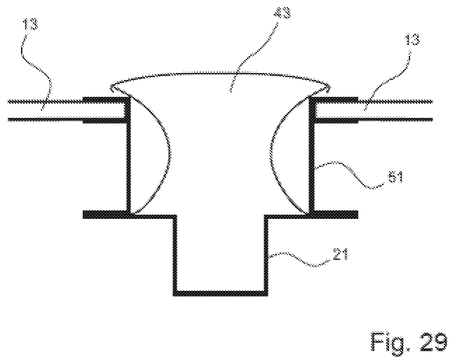

The “L”-shaped ribs are configured in separate rails 21. and 21.2 in FIG. 28 and FIG. 29, which rails in turn are arranged between the frames 44.

The rain gutter 21, which is configured as a hat-shaped profile, is arranged below the fastening rails 51 in FIG. 29.

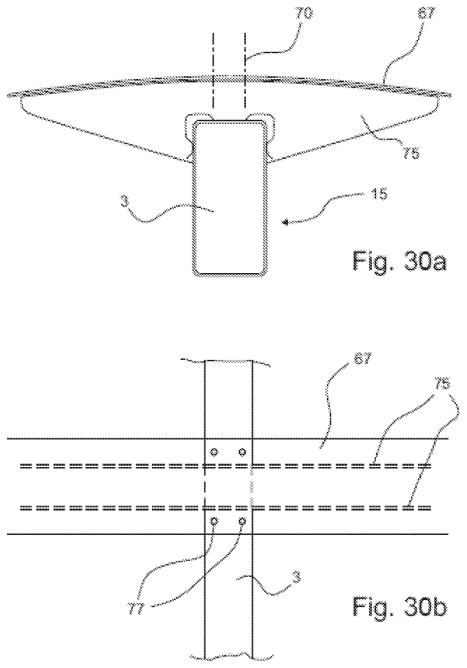

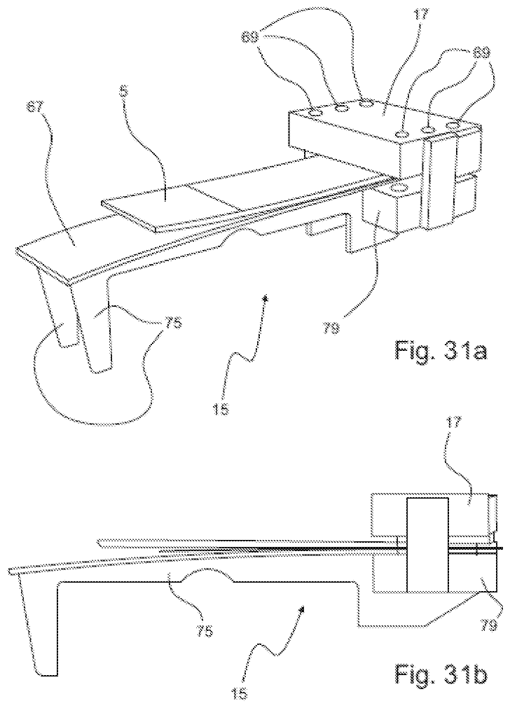

A further embodiment example of a saddle component 15 according to the invention is shown in two views in FIG. 30a and FIG. 30b. A side view is shown in FIG. 31a, whereas a top view is shown in FIG. 31b.

In this embodiment example, the cross-member 3 is configured as a hollow section, namely a rectangular tube. Two ribs 75 are applied and welded to the top of the cross-member 3. The upper sides of the ribs 75 are curved and bear a seating 67 which is also curved. This saddle component 15 is preferably configured as a welded construction.

It can be seen from the view from above (FIG. 30b) that the ribs 75 have a certain distance to each other and that the seating 67 has punch-throughs 77. The distance between the punch-throughs 77 is greater than the width of the tensioning strap 5. The tensioning strap 5 (not shown in FIG. 31a and FIG. 31b) is placed on the seating 67 between the punch-throughs 77. Subsequently, in a manner similar to the embodiment examples according to FIG. 9 and FIG. 10, a counterpiece 17 is placed on top and the counterpiece 17 is pressed against the seating 67 with the aid of clamping screws 69, which are inserted through the punch-throughs 77. This creates a frictional connection between the tensioning strap 5 and the saddle component 15 or alternatively the cross-member 3.

FIG. 31a and FIG. 31b show a further embodiment example of a saddle component 15 according to the invention, which is executed as a welded construction. The saddle component 15 comprises two ribs 75 and a seating 67. It is configured in a manner very similar to the embodiment example according to FIG. 31. The substantial difference is that a base plate 79 is arranged in the right-hand area of the ribs 75 in FIG. 31a and FIG. 31b. This base plate 79 projects beyond the seating 67 on both sides. The solid base plate 79 can be provided with threaded holes or punch-throughs which, together with a counterpiece 17 and the clamping screws 69, form a frictional connection between the tensioning strap 5 and the saddle component 15 or alternatively the cross-member 3.

In this embodiment example, the strength and load capacities required at the various locations can be constructively specified through the selection of suitable material thicknesses and geometries. The base plate 79 can, in particular, be executed to be very solid so that very high clamping forces can be achieved between the counterpiece 17 and the base plate 79.

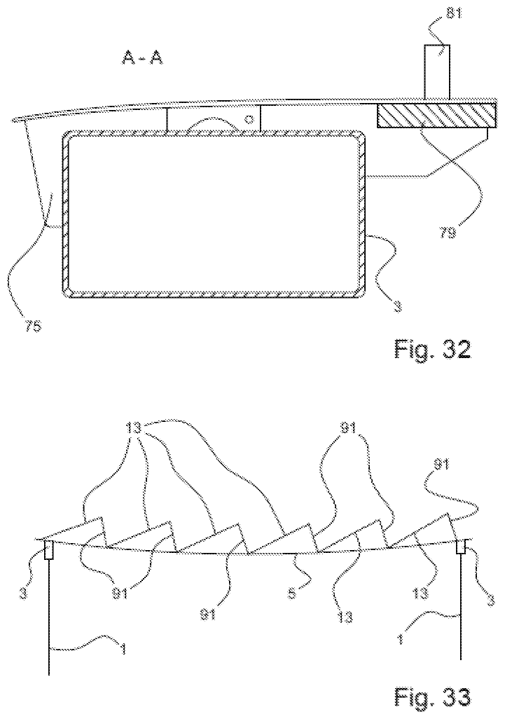

A cross-member 3 executed as a square tube is shown in a cross-sectional view in FIG. 32 with a welded-on saddle component 15 according to FIG. 31a and FIG. 31b.

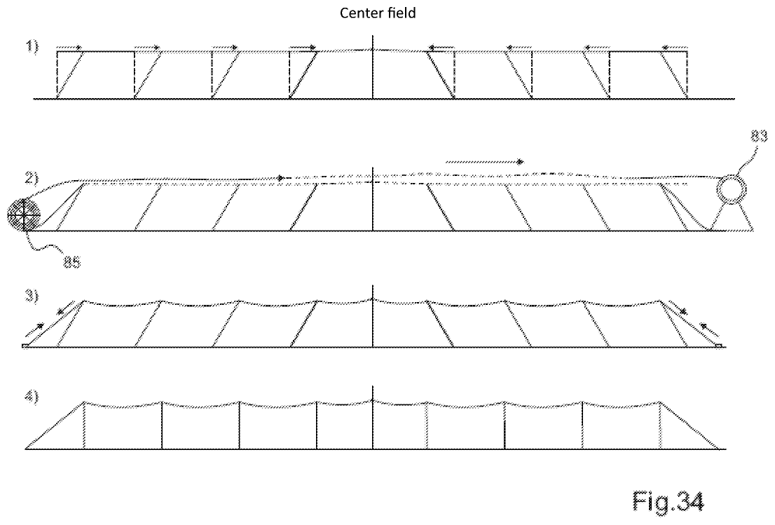

FIG. 33 shows an embodiment example of a support structure with elevated PV modules 13. The orientation of the PV modules 13 to the sun can be improved by elevating them, thereby increasing the yield.

FIG. 34 shows the erection of a support structure according to the invention in four steps. In the first step (Step 1), only the middle row of supports 1 is vertically oriented. With an increase in the distance to the central support 1, adjacent supports 1 are arranged at an ever-increasing angle. The outermost supports 1 are at the most oblique angle.

In a second step (step 2)), it is now indicated how the tensioning strap 5 is pulled over the supports 1 or alternatively the cross-members 3 with the aid of a winch 83 from a reel 85 or roller.

The support structure that has not yet been pretensioned is shown in FIG. 34.3 (Step 3)), and it is indicated by the arrows that the traction means 11 are now shortened so that the supports are oriented and the tensioning strap 5 is given the desired pretension.

The completed support structure is shown in FIG. 34.4. All supports 1 are vertically oriented, the tensioning straps 5 have the desired pretension and the pretensioning force is diverted via the traction means 11 to the footings not shown in FIG. 31.

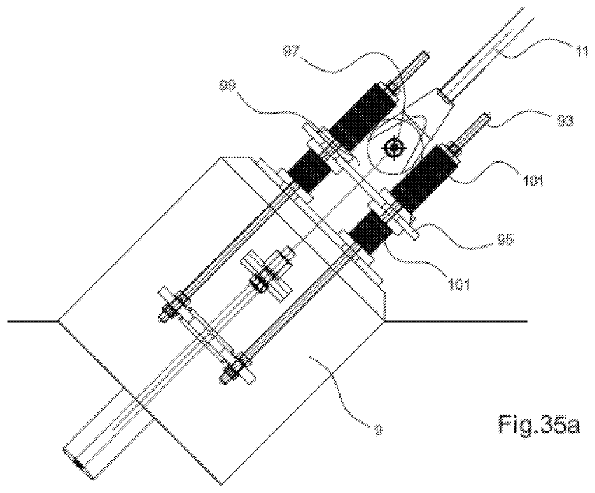

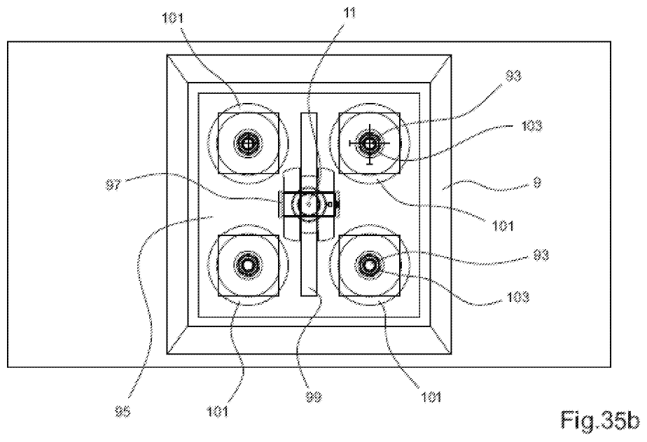

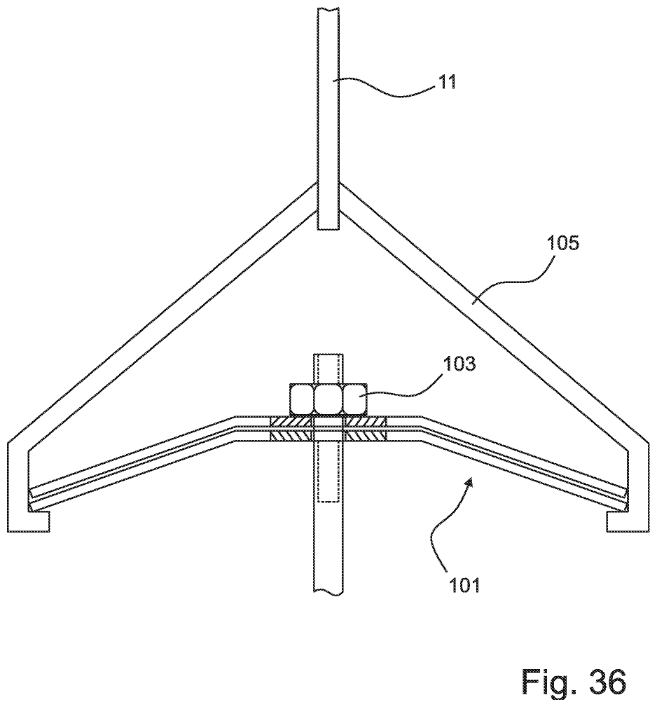

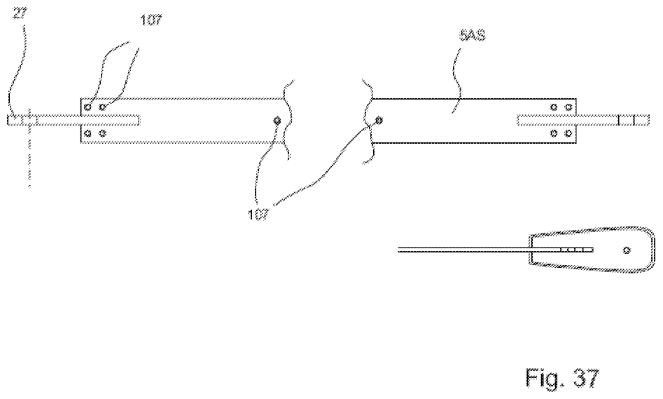

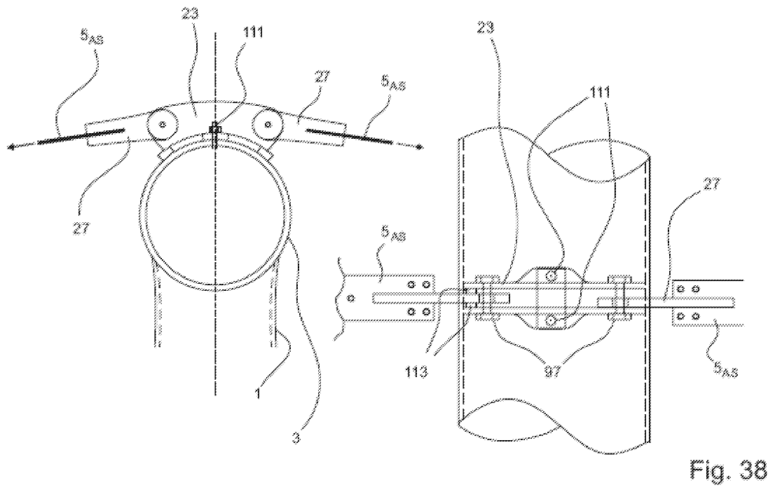

In the embodiment examples shown in FIG. 35a, FIG. 35b and FIG. 36, one or a plurality of springs, preferably disk spring assemblies, are arranged between the footing 9 and the traction means 11.

In the embodiment example shown in FIG. 35a and FIG. 35b, there are 2×4 disk spring assemblies 101.

Several threaded rods 93 are arranged in the footing 9.

A load distribution plate 95 is slid onto these threaded rods 93. For this purpose, through holes (without reference signs) are provided in the load distribution plate 95. The load distribution plate 95 can move along the threaded rod 93 relative to the footing 9.

The traction means 11 is hooked to the load distribution plate 95. This can be done by means of a stud 97, which is inserted into a flange plate 99, which in turn is welded to the load distribution plate 95.

The aforementioned disk spring assemblies 101 are slid onto the threaded rod 93. In the embodiment example shown, a disk spring assembly 101 is respectively arranged on each threaded rod 93 below and above the load distribution plate 95. Nuts 103 are then threaded onto the threaded rod 93. Tightening the nuts 103 pretensions the disk spring assembly 101 and the traction means 11.

Due to the arrangement of disk springs below and above the load distribution plate 95 to which the traction means 11 is attached, the disk spring assemblies 101 can work in both directions.

This means that at higher loads (high loads due to snow and wind), the springs arranged above the load distribution plate 95 compress so that the bracing can yield somewhat. All supports 1 tilt inwards and the sag of the tensioning straps 5 increases. As a result, the increase in the forces acting on the supports 1 and their footings is reduced or can even be kept constant; this notwithstanding the increased loads.

In the event of wind suction loads, a drop in pretension is prevented. The disk springs above the load distribution plate 95 elongate, which is to say that the supports 1 are pulled outwards and the tensioning straps 5 still remain pretensioned; there is no shock-like passage of the tensioning straps 5 through the zero position, but rather a static/“gentle” passage into the upwardly curved region of the vibrational amplitude.

The spring rates of the disk spring assembly 101 below and above the load distribution plate 95 may be the same. It may, however, also be advantageous if the spring rates of the disk spring assembly 101 below and above the load distribution plate 95 are different. For example, this measure can positively influence the vibrational behavior of the PV system. This means that the amplitudes are reduced.

In any case, it must be ensured that the load distribution plate 95 and the footing 9 do not touch one another at any time.

It can also be advantageous to limit the travel of the stop plate 95 in one or both directions. This prevents excessive deformation, for example, due to wind friction, and the associated excessive “tilting” of supports 1.

In short, by using the disk spring assembly 101, the pretension of the tensioning strap 5 can be reduced. It is nevertheless ensured that the tensioning straps 5 are pretensioned at all times and in all places; even if the tensioning straps 5 are excited to vibrate by wind. This reduces the load, in particular, on the tensioning straps 5, but also on the other components of the PV system, and allows greater slack in the tensioning straps 5 between the cross-members 3.

A further embodiment with only one disk spring assembly 101 is shown in FIG. 36. In this embodiment, a disk spring assembly 101 is slid onto the threaded rod 103.

The lower end of the traction means 11 is hooked to the disk spring assembly 101 via a bracket 105. In this embodiment example too, the disk spring assembly 101 and the traction means 11 are pretensioned by tightening the nut 103.

FIG. 37 and FIG. 38 show details of another embodiment of a PV system in which the tensioning straps 5 do not extend from the first cross-member 3, to the last cross-member 3ₙ. This embodiment was illustrated and elucidated in the first German application DE 10 2021 111 106.4 in FIG. 8 and FIG. 9.

In this embodiment example, each tensioning strap 5 consists of several tensioning strap sections 5_{AS}. The length of a tensioning strap section corresponds approximately to the distance between two adjacent cross-members 3. This means that a fastening piece 23, which has two holes, is mounted on the cross-member 3, which in FIG. 38 is configured as a tube with a circular cross-section. The fastening pieces 23 are attached to the cross-member 3 with screws 111 or welding studs.

In this embodiment example, an intermediate piece 27 which likewise has a bore is provided at the ends of the tensioning strap sections 5_{AS}. A stud or a screw can, for example, be inserted through these bores and in this way two tensioning strap sections 5_{AS} can be attached to a cross-member 3. This coupling connects several tensioning strap sections 5_{AS} to form a continuous tensioning strap 5. Screws (without reference signs) are employed in the top view of FIG. 38. They are secured by nuts.

Spacer sleeves 113 can be arranged on the screws between the fastening piece 23 and the intermediate piece 27 to prevent direct contact between the fastening piece 23 and the intermediate piece 27.

It is, however, also possible to dispense with the intermediate piece 27 if the fastening piece 23 is executed accordingly. By way of example, when the axes of the holes in the fastening piece 23 run parallel to the longitudinal axis of the support 1. One end of a tensioning strap section 5_{AS} can then be hooked directly into this bore or tensioned with the fastening piece 23 using a stud or a screw.

The fastening piece 23 can also be executed as a stationary metal sheet that is welded to the cross-member 3.

### LIST OF REFERENCE SIGNS

1 Support
3 Cross-member: “n” number of cross-members
5 Tensioning strap; “m” number of tensioning straps
7 Crossing point
9 Footing
11 Traction means
13 PV module
15 Saddle component
17 Counterpiece
19 Sealing profile/sealing strip, flexible, for example, made of EPDM
21 Rain gutter, flexible, for example, made of EPDM
23 Fastening piece
25
27 Connecting piece
29 Hand hole
31 Counterpiece
33 Screw
35, 35-1, 35-2 Clamping element
37 Upper clamping piece
39 Lower clamping piece
41 Tensioning screw
43 Sealing strip
44 Aluminum module frame of a PV module
44-1/44-2 PV frame with T- and L-shaped ribs.
44-3/44-4 Additional sealing
45 Foot
47 Pressure piece
49 Resilient element
50 Groove
60 Connecting piece
61 Metal sheet tab
62 Split pin, pin, or screw
63 Oblong hole
64 Mounting hole
65 Trapezoidal metal sheet
67 Seating
69 Clamping screw
70 Load distribution plate
71 Bending part
73 Dash-dotted line
75 Rib
77 Punch-through
79 Base plate
81 Stop
83 Winch
85 Reel
87 Sealing strip
93 Threaded rod
95 Load distribution plate
97 Stud
99 Flange plate
101 Disk spring assembly
103 Nut
105 Bracket
107 -
109 -
111 Fastening screw
113 Spacer sleeve

1. Support structure for photovoltaic modules, comprising a plurality of rows of supports (1) extending side by side and a plurality of tensioning straps (5) running side by side, wherein the supports (1) of a row are respectively connected to each other by a cross-member (3), wherein the tensioning straps (5) run transversely to the cross-members (3) and wherein photovoltaic modules are arranged on the tensioning straps (5), and wherein the tensioning straps (5) are fastened to the cross-member (3) at the crossing points (7) of a cross-member (3) and a tensioning strap (5) by means of a screw connection or a clamp connection, characterized in that the tensioning straps (5) are made of steel sheet.

2. Support structure according to claim 1, characterized in that punch-throughs are provided in the tensioning straps (5) for attaching PV modules (13) to the tensioning strap (5) and/or for attaching the tensioning straps (5) to the cross-member (3) at the crossing points (7) between a cross-member (3) and a tensioning strap (5).

3. Support structure according to either claim 1, characterized in that the upper side of the cross-member (3) is curved in a convex manner at least at the crossing points (7) of a cross-member (3) and a tensioning strap (5) and in that the tensioning strap (5) rests on the curved upper side of the cross-member (3).

4. Support structure according to either claim 1, characterized in that the tensioning strap (5) runs below the cross-member (3) and is connected to a cross-member (3) at the crossing points (7).

5. Support structure according to either claim 3, characterized in that the tensioning straps (5) are connected in a force-fit or form-fit manner to the cross-member (3) at the crossing points (7).

6. Support structure according to claim 1, characterized in that a tensioning strap (5) is composed of a plurality of tensioning strap sections (5AS), and that a tensioning strap section (5AS) is fastened between two cross-members (3).

7. Support structure according to claim 1, characterized in that each tensioning strap (5) starts at a first cross-member (31) and ends at a last cross-member ((3n)), and in that the tensioning straps (5) are mounted with a pre-tension between the first cross-member (31) and the last cross-member (3n).

8. Support structure according to claim 7, characterized in that the elongation of the pretensioned tensioning straps (5) is so great that, even in the case of wind-induced vibrations, the tensioning straps (5) are always pretensioned, even in the case of zero crossing of a vibration, including in the case of a “break-through”, which is to say when they do not sag as an arc, but rather when they are (dynamically) arranged in a perfectly horizontal manner, which is to say when they “occupy” the shortest connection between two adjacent seating points.

9. Support structure according to claim 1, characterized in that it comprises at least two footings (9.1, 9.2), in that a first footing (9.1) extends next to the first cross-member (31), in that a second footing (9.2) extends next to the last cross-member (3n), in that traction means (11) are provided between the first footing (9.1) and the first cross-member (31) as well as the second footing (9.2) and the last cross-member (3n), which traction means divert the pretensioning introduced by the tensioning straps (5) into the first cross-member (31) and the last cross-member (3n) into the footings (9.1, 9.2).

10. Support structure according to claim 1, characterized in that the cross-members (3) are constructed of a wide flange beam, of a hollow section, in particular a steel tube, or of wood, in particular structural solid wood, with a round or polygonal cross-section.

11. Support structure according to claim 1, characterized in that the upper sides of the cross-members (3) are curved and form a seating for the tensioning straps (5).

12. Support structure according to claim 3, characterized in that a saddle component (15) for a tensioning strap (5) is provided at the crossing points (7), and in that the saddle components (15) are connected to the cross-members (3).

13. Support structure according to claim 12, characterized in that each saddle component (15) comprises a curved seating (67) and a counterpiece (17), in that the tensioning strap (5) is passed between the seating (67) and the counterpiece (17), and in that the counterpiece (17) is pressed against the seating (67) by means of clamping screws (69).

14. Support structure according to claim 12, characterized in that the saddle components (15) comprise one or two ribs (75), in that the seating (67) is attached to the rib or ribs (75), and in that a base plate (79) is arranged below the seating (67) on the rib or ribs (75), and in that the base plate (79) has punch-throughs or threaded holes that work together with the clamping screws (69).

15. Support structure according to claim 1, characterized in that each PV module (13) is directly or indirectly attached to two adjacent tensioning straps (5).

16. Support structure according to claim 15, characterized in that the PV modules (13) comprise a frame (44), and in that the PV modules (13) are attached to two tensioning straps (5) located side by side by means of the frame (44).

17. Support structure according to claim 1, characterized in that the PV modules (13) are attached to the tensioning straps (5) in an elevated position.

18. Support structure according to claim 1, characterized in that a sealing strip (19, 43) is provided between two adjacent PV modules (13) or two adjacent rows of PV modules (13).

19. Support structure according to claim 1, characterized in that a trapezoidal metal sheet (65) is provided between the tensioning straps (5) and the PV modules (13).

20. Support structure according to claim 9, characterized in that at least one disk spring assembly (101) is arranged between a tensioning member (11) and a footing (9).
